(19) United States
(12) Patent Application Publication
(10) Pub. No.: US 2011/0110589 A1
(43) Pub. Date: May 12, 2011

(54) Image Contrast Enhancement

(75) Inventors: Jonathan Yen, San Jose, CA (US); William C. Kress, Mission Viejo, CA (US)

(73) Assignees: Kabushiki Kaisha Toshiba, Minato-ku (JP); Toshiba Tec Kabushiki Kaisha, Shinagawa-ku (JP)

(21) Appl. No.: 12/941,572

(22) Filed: Nov. 8, 2010

Related U.S. Application Data
(60) Provisional application No. 61/258,705, filed on Nov. 6, 2009.

(51) Int. Cl. G06K 9/00

(52) U.S. Cl. 382/168

(57) ABSTRACT

The subject application is directed to a system and method for image contrast enhancement. Input image comprised of digitally encoded image data is received into a data processor, including an associated data storage, and histogram data is generated corresponding to received image data. Acceptability of received image data is determined in accordance with a comparison of the histogram data to at least one preselected threshold value and a contrast adjustment including a white stretch, a black stretch, and a contrast stretch is performed on the input image in accordance with the histogram data.

### CROSS-REFERENCE TO RELATED APPLICATIONS

This application claims priority to U.S. Provisional Patent Application Ser. No. 61/258,705, filed on Nov. 6, 2009, titled “AUTOMATIC CONTRAST ENHANCEMENT”, the entirety of which is incorporated by reference herein.

### FIELD

The present application relates generally to contrast enhancement of digitally encoded images and to improved, automatic contrast enhancement that avoids application of enhancement to certain categories of images.

### BACKGROUND

Images include visual properties such as contrast, which is a property that makes an object distinguishable from other objects or background depicted in the image by relative lightness and darkness. Often visual properties of an image can be approved by adjusting contrast. When images are captured in a digitally encoded format, mathematical manipulation of corresponding image data can be used to adjust contrast of a resultant rendered image.

Alterations in contrast are frequently completed by computer users who can manipulate image data using suitable software. However, it is difficult for users to generate an improved image using manual adjustment of contrast properties. Automated contrast adjustment exists, but may be applied to all images, irrespective of image type. This may result in degraded image quality or negation of intentional image effects. In addition, automated contrast adjustment is frequently made solely on properties of one particular image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The subject application is described with reference to certain figures, including:

FIG. 1 is an overall diagram of a system for image contrast enhancement according to one embodiment of the subject application;

FIG. 2 is a block diagram illustrating device hardware for use in the system for image contrast enhancement according to one embodiment of the subject application;

FIG. 3 is a functional diagram illustrating the device for use in the system for image contrast enhancement according to one embodiment of the subject application;

FIG. 4 is a block diagram illustrating controller hardware for use in the system for image contrast enhancement according to one embodiment of the subject application;

FIG. 5 is a functional diagram illustrating the controller for use in the system for image contrast enhancement according to one embodiment of the subject application;

FIG. 6 is a diagram illustrating a workstation for use in the system for image contrast enhancement according to one embodiment of the subject application;

FIG. 7 is a block diagram illustrating the system for image contrast enhancement according to one embodiment of the subject application;

FIG. 8 is a functional diagram illustrating the system for image contrast enhancement according to one embodiment of the subject application;

FIG. 9 is a flowchart illustrating a method for image contrast enhancement according to one embodiment of the subject application;

FIG. 10 is a flowchart illustrating a method for image contrast enhancement according to one embodiment of the subject application;

FIG. 11 is an example illustration of an input and output image for use in the system and method for image contrast enhancement according to one embodiment of the subject application;

FIG. 12 is an example of scenes inappropriate for contrast enhancement in accordance with the system and method for image contrast enhancement according to one embodiment of the subject application;

FIG. 13 is an example of automatic contrast enhancement in accordance with the system and method for image contrast enhancement of one embodiment of the subject application;

FIG. 14 is a series of tone curves for use in the system and method for image contrast enhancement according to one embodiment of the subject application;

FIG. 15 is a tone reproduction curve for use in the system and method for image contrast enhancement according to one embodiment of the subject application;

FIG. 16 is a graphical representation of a quadratic interpolation for use in the system and method for image contrast enhancement according to one embodiment of the subject application; and

FIG. 17 is a flowchart illustrating an example implementation of the method and system for image contrast enhancement in accordance with one embodiment of the subject application.

### DETAILED DESCRIPTION

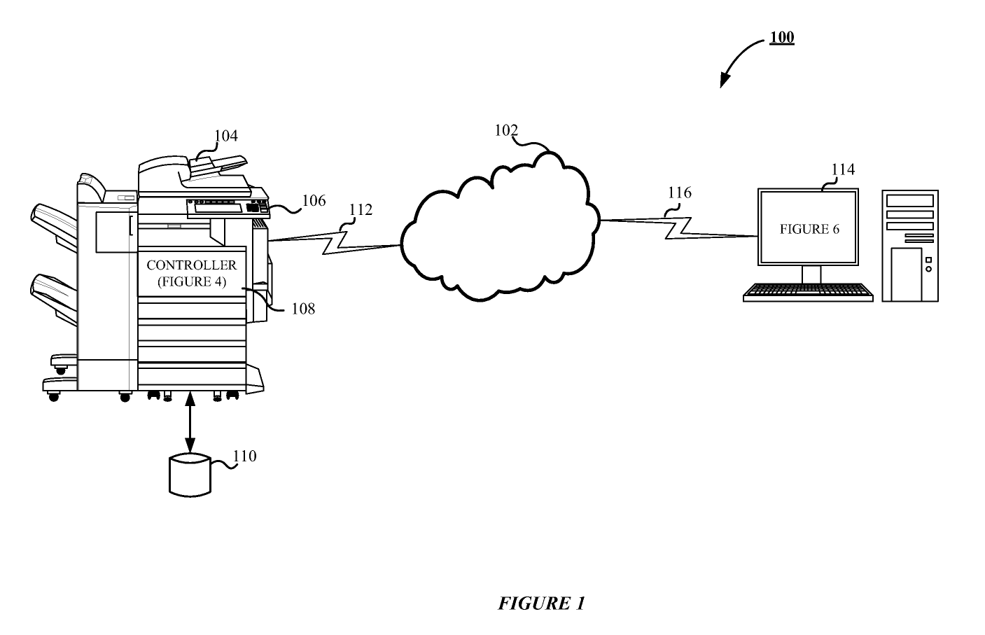

The subject application is directed to a system and method for image contrast enhancement. The subject application is directed generally to contrast enhancement of digitally encoded images and is particularly applicable to improved, automatic contrast enhancement that avoids application of enhancement to certain categories of images. In this patent, the terms “automatic” and “automatically” mean “without operator involvement”. It will become apparent to those skilled in the art that the system and method described herein are suitably adapted to a plurality of varying electronic fields employing iterative processing, including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of an example system 100 for implementation of image contrast enhancement in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. According to one particular embodiment of the subject application, the document processing device 104 includes an audio reproduction component (not shown) such as a speaker, or the like, capable of emitting tones, sounds, warnings, and the like.

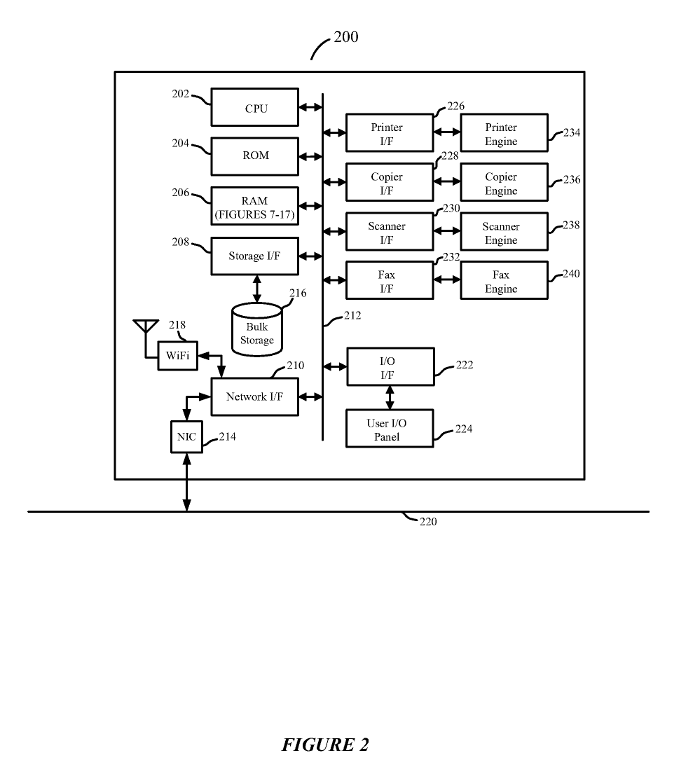

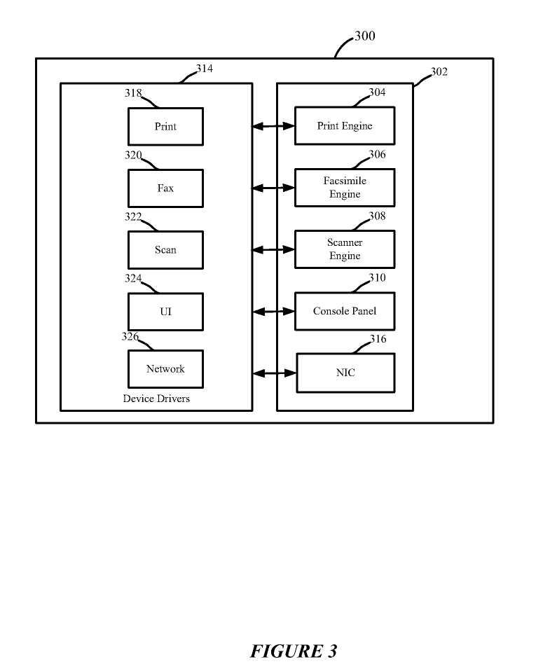

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

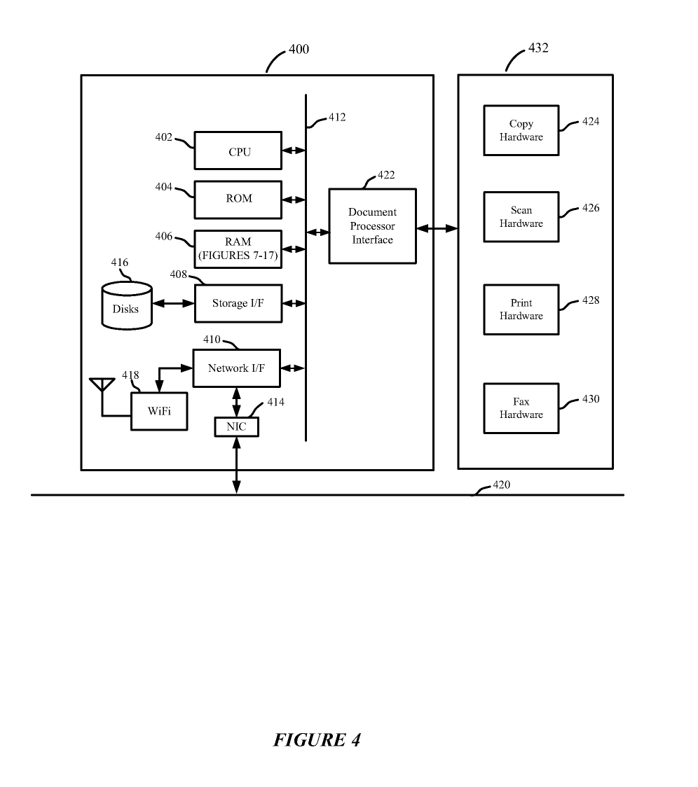

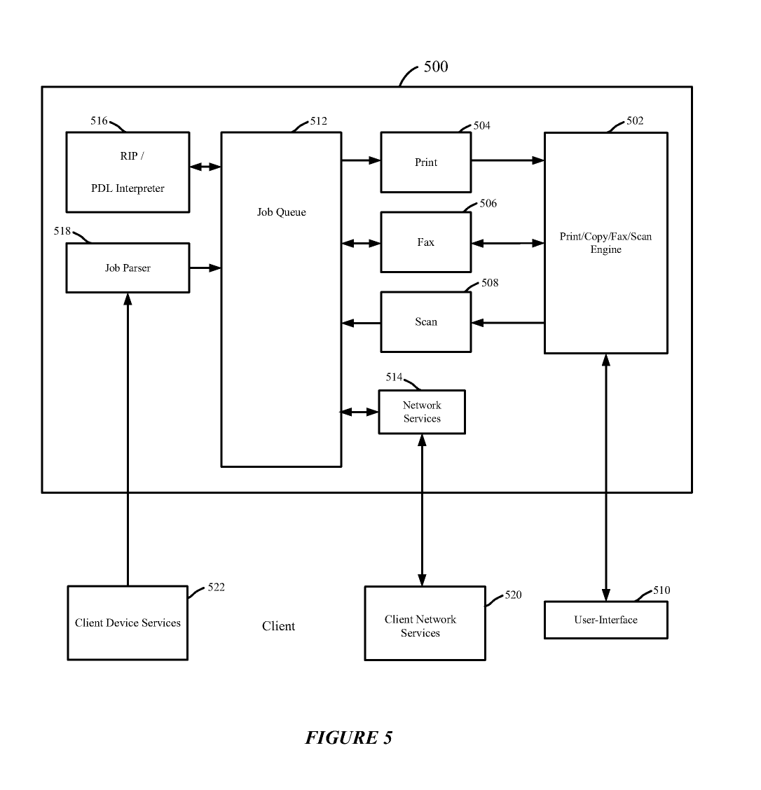

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for image contrast enhancement. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, color measurement data, color calibration data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

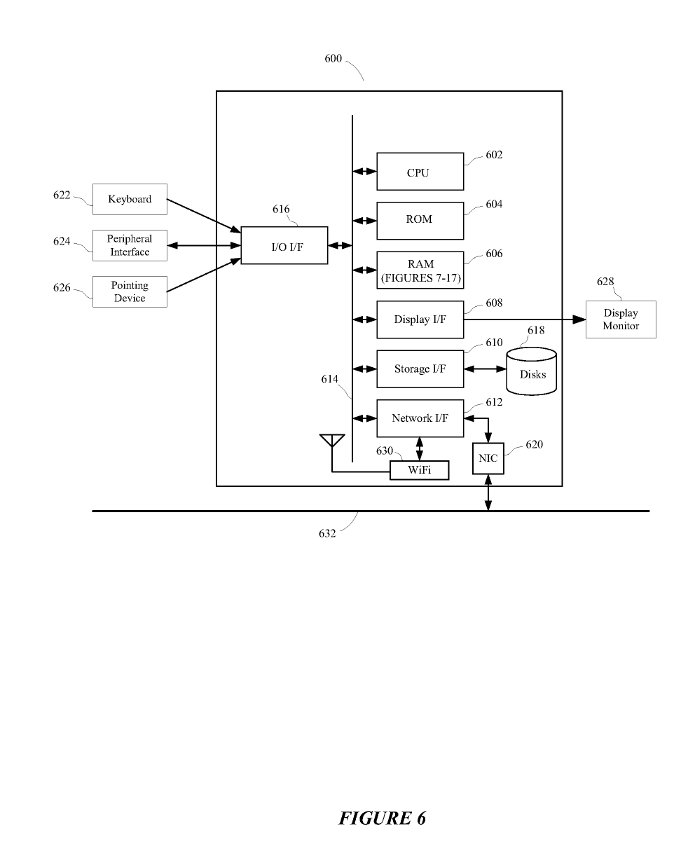

Depicted in FIG. 1 is a user device 114, illustrated as a computer workstation in data communication with the computer network 102 via a communications link 116. It will be appreciated by those skilled in the art that the user device 114 is shown in FIG. 1 as a computer workstation for illustration purposes only. As will be understood by those skilled in the art, the user device 114 is representative of any personal computing device known in the art including, for example and without limitation, a laptop computer, a workstation computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In accordance with one embodiment of the subject application, the user device 114 is suitably configured to facilitate the image contrast enhancement and facilitate communication with the document processing device 104. According to one particular embodiment of the subject application, the user device 114 includes an audio reproduction component (not shown) such as a speaker, or the like, capable of emitting tones, sounds, warnings, and the like. The functioning of the user device 114 will better be understood in conjunction with the diagram illustrated in FIG. 6, explained in greater detail below.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is then incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In a preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown as the user device 114, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

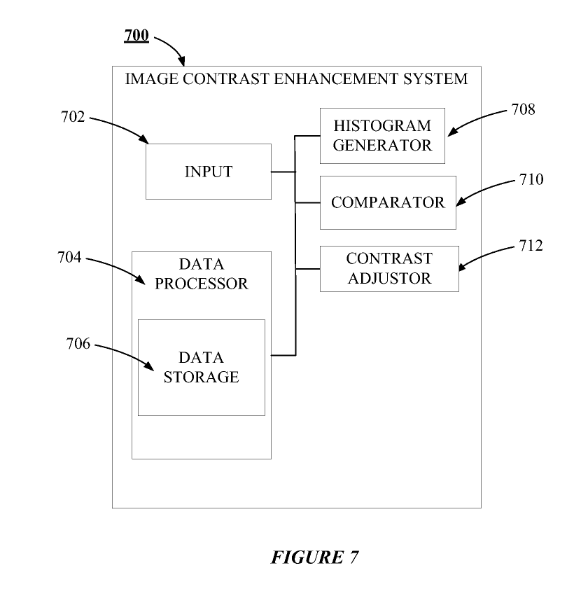

Turning now to FIG. 7, illustrated is a block diagram of an image contrast enhancement system 700 in accordance with one embodiment of the subject application. The system 700 includes an input 702 that is configured to receive an input image into a data processor 704 that has an associated data storage 706. Preferably, the input image consists of digitally encoded image data, as will be appreciated by those skilled in the art. The system 700 further employs a histogram generator 708 that is capable of generating histogram data that corresponds to the received image data. A comparator 710 is also used by the image contrast enhancement system 700 of FIG. 7. The comparator 710 is preferably configured to detect the acceptability of the received image data based upon a comparison of the histogram data to one or more preselected threshold values. The system 700 further incorporates a contrast adjustor 712 that is selectively operated in connection with the output of the comparator 710. The contrast adjustor 712 is suitably capable of performing white stretch, black stretch, and contrast stretch on the input image based upon the histogram data.

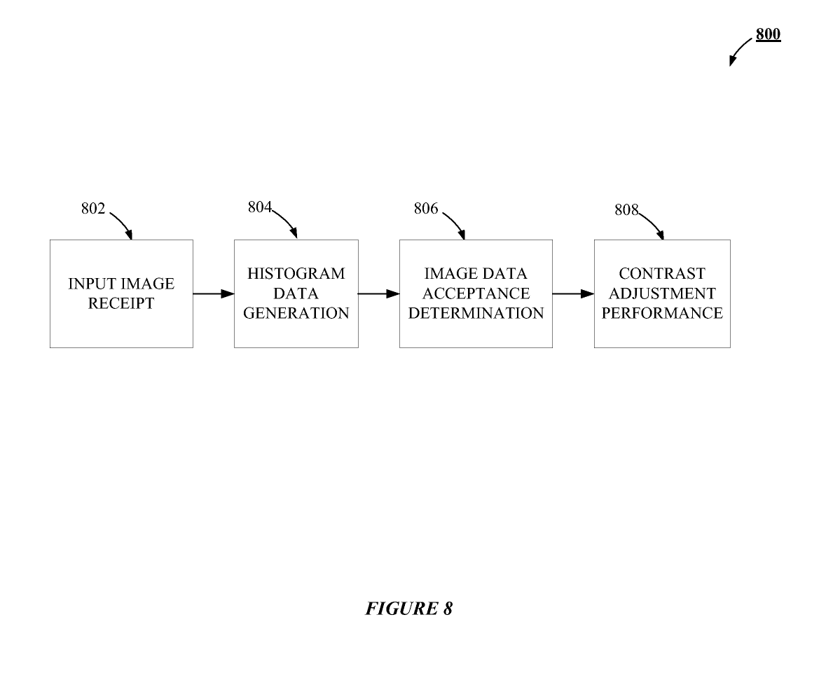

Referring now to FIG. 8, there is shown a functional diagram illustrating the system 800 for image contrast enhancement in accordance with one embodiment of the subject application. Input image receipt 802 first occurs of digitally encoded image data into a data processor that includes an associated data storage. Via the processor, histogram data generation 804 is performed of histogram data corresponding to the received image data. Image data acceptance determination 806 is then performed of the acceptability of the received image data based upon a comparison of the histogram data and one or more threshold values. Contrast adjustment performance 808, including white stretch, black stretch, and contrast stretch, then occurs on the input image based upon the histogram data.

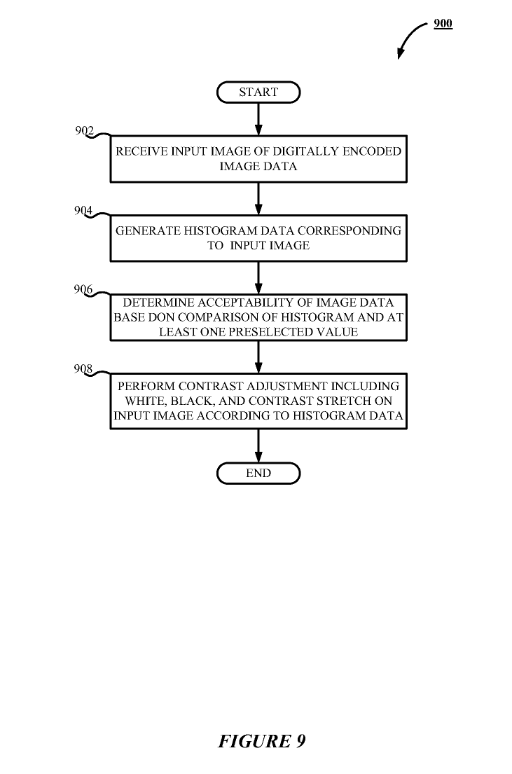

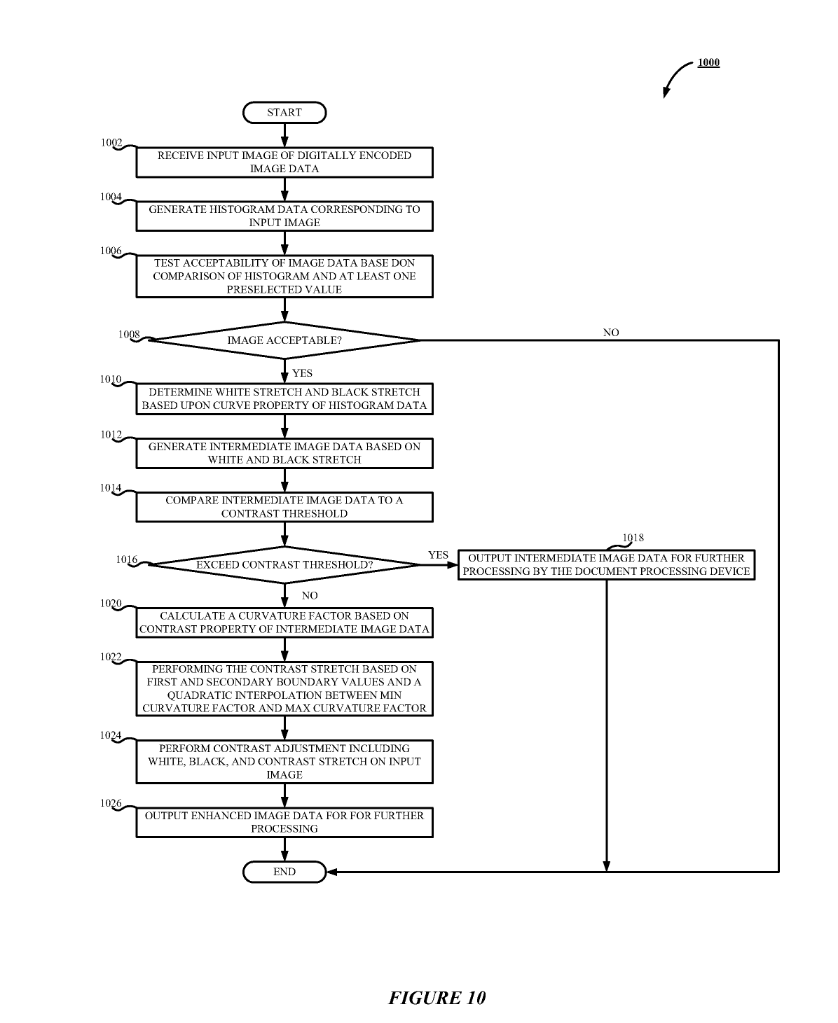

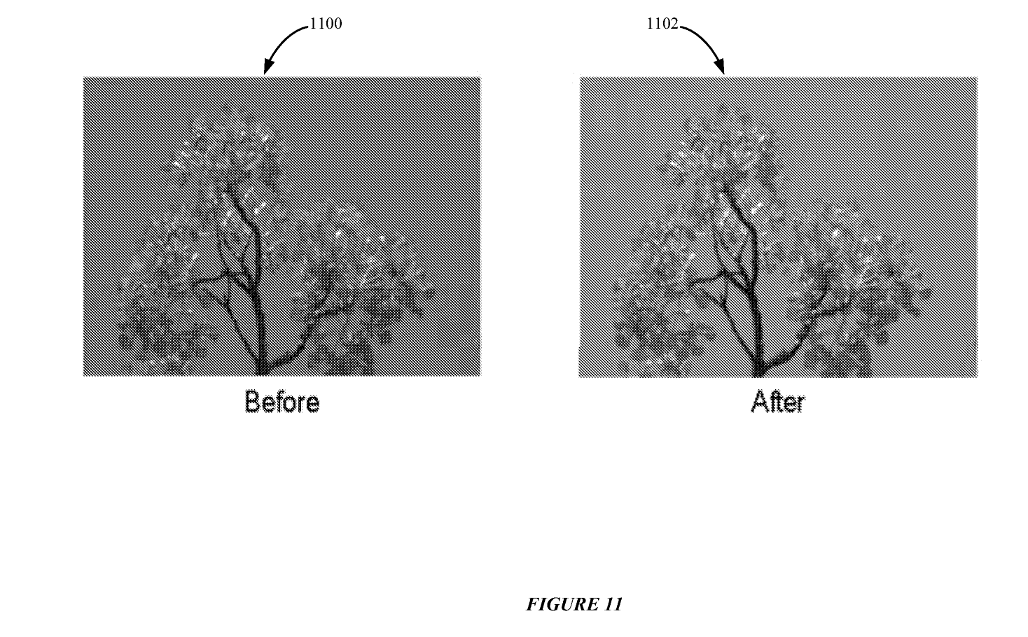

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example illustrations of FIGS. 11-17. Turning now to FIG. 9, there is shown a flowchart 900 illustrating an image contrast enhancement method in accordance with one embodiment of the subject application. Beginning at step 902, an input image is received that is comprised of digitally encoded image data. Preferably, the input image is received at step 902 into a data processor that includes an associated data storage.

At step 904, the processor generates histogram data corresponding to the received image data. It will be appreciated by those skilled in the art that such generation includes the calculation of the histogram from the received encoded image. The acceptability of the received image data is then determined at step 906 in accordance with a comparison that is performed of the histogram data and at least one preselected threshold value. At step 908, a contrast adjustment is performed on the input image based upon the histogram data. Preferably, the contrast adjustment includes a white stretch, a black stretch, and a contrast stretch.

Referring now to FIG. 10, there is shown a flowchart 1000 illustrating a method for image contrast enhancement in accordance with one embodiment of the subject application. The methodology of FIG. 10 begins at step 1002, whereupon an input image of digitally encoded image data is received by the controller 108 or other suitable component associated with the document processing device 104, the user device 114, or other suitable processing device, as will be appreciated by those skilled in the art. At step 1004, histogram data is generated, e.g. calculated, corresponding to the received input image via the controller 108, the user device 114, or the like. The acceptability of the image data is then tested at step 1006 based upon a comparison of the calculated histogram and one or more preselected values. In accordance with one embodiment of the subject application, the acceptability of the input image is determined based upon the type of input image, e.g. certain scenes (fog, dark, bright, artistic, etc.) are not suitable for contrast enhancement. Such a determination is made in accordance with the calculated histogram data, as discussed in greater detail below.

A determination is then made at step 1008 whether the input image is acceptable for image contrast enhancement in accordance with one embodiment of the subject application. In the event that the input image is not acceptable, i.e. the image is an artistic, fog, dark, or bright scene, operations with respect to FIG. 10 terminate. When it is determined at step 1008 that the image is acceptable for contrast enhancement, flow proceeds to step 1010. At step 1010, the white stretch (WS) and the black stretch (BS) are determined from at least one curve property of the histogram data by the controller 108, the user device 114, or the like. In accordance with one embodiment of the subject application, the curve property from which the white stretch is determined is the length of the long tail of the image histogram, while the curve property from which the black stretch is determined is the length of the long ramp of the image histogram, as discussed in greater detail below with respect to FIGS. 11-17.

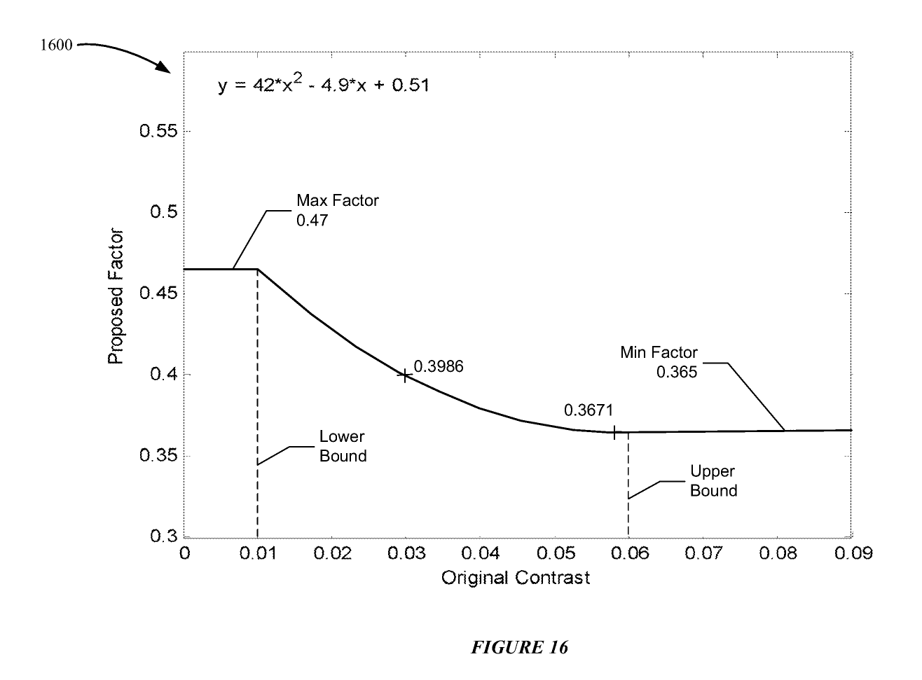

At step 1012, intermediate image data is generated in accordance with the determined white stretch and black stretch. According to one example embodiment, and as illustrated more fully below, the intermediate image data is generated by application of the white stretch amount plus the black stretch amount to the input image data. The intermediate image data is then compared at step 1014 to a contrast threshold. That is, a calculated contrast value associated with the intermediate image data is tested against a predetermined contrast threshold. In accordance with one example embodiment of the subject application, the contrast threshold corresponds to the contrast measurement associated with the intermediate image. For example purposes only, the contrast measurement of the subject application corresponds to the variance of the standard deviation from the brightness average of the input image. In such an example embodiment, the threshold corresponds to an upper bound contrast, e.g. illustrated more fully in FIG. 16 below.

A determination is then made at step 1016 whether the intermediate image data exceeds the predetermined contrast threshold. When the calculated contrast of the intermediate image exceeds the contrast threshold, flow proceeds to step 1018, whereupon the intermediate image data is output for further processing by the document processing device 104, the user device 114, or the like. Thereafter, operations with respect to FIG. 10 terminate. Upon a determination at step 1016 that the intermediate image data does not exceed the contrast threshold, flow progresses in FIG. 10 for completion of contrast enhancement of the input image. Thus, at step 1020, a curvature factor is calculated based upon a contrast property of the intermediate image data. For example, the controller 108, user device 114, or the like calculates the curvature factor based upon the contrast measurement of the intermediate image data. Suitable examples of such factor calculations are discussed in greater detail below with respect to FIGS. 11-17.

At step 1022, contrast stretch is performed based upon a first and a second boundary value and a quadratic interpolation between a minimum curvature factor and a maximum curvature factor. Preferably, at least one preselected boundary value, as discussed below, is used in the contrast stretch of step 1022. Thereafter, at step 1024, contrast adjustment is performed on the input image data using the white, black, and contrast stretch. The contrast enhanced image is then output for further processing at step 1026, whereupon operations with respect to FIG. 10 terminate.

The preceding example methodologies will be better understood in conjunction with the illustrations of FIGS. 11-17 relating to automatically enhancing the image contrast. Turning now to FIG. 11, there is shown an input image 1100 and the effect of automatic contrast enhancement as the output image 1102. In accordance with one embodiment of the subject application, the system and methodology automatically detects if it is appropriate to apply contrast enhancement, detects if it is necessary to apply contrast enhancement, determines how much the contrast enhancement, and applies the determined contrast enhancement.

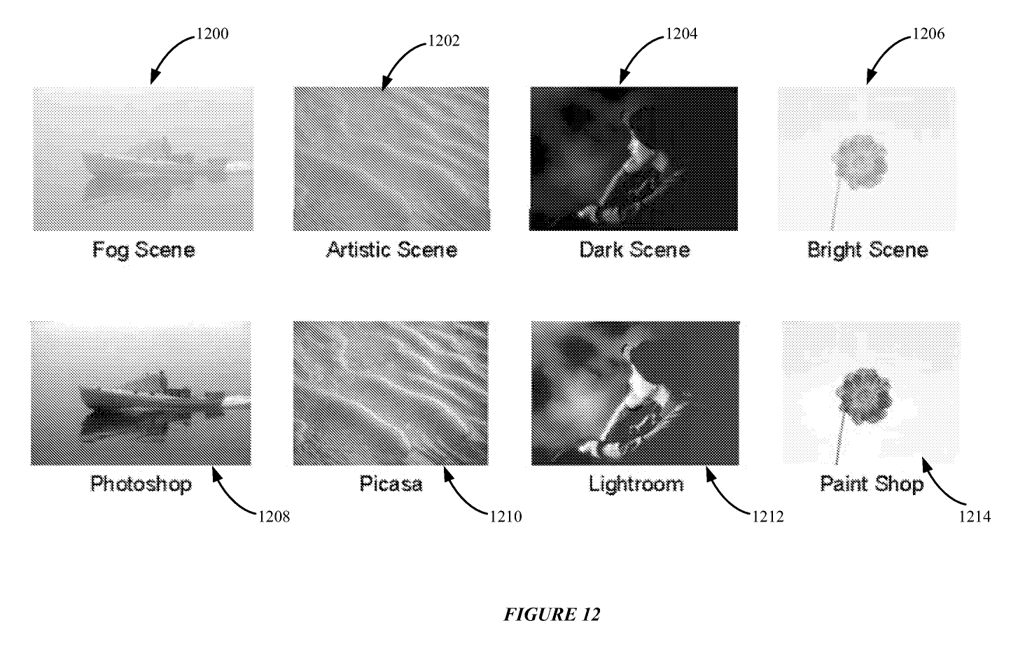

According to one embodiment of the subject application, image contrast enhancement is capable of being restricted as inappropriate for application to some specific scenes, e.g. illustrated in FIG. 12 as fog scenes and partial fog scenes 1200, artistic scenes 1202, dark scenes 1204, and bright scenes 1206. FIG. 12 also shows the results of these scenes 1200-1206 applied with “Auto Contrast” or “Auto Tone” by ADOBE PHOTOSHOP (image 1208), GOOGLE PICASA (image 1210), ADOBE LIGHTROOM (image 1212), and COREL PAINT SHOP (image 1214), respectively. The systems and methods of the subject application perform scene analysis to avoid applying contrast enhancement to fog scenes and partial fog scenes, artistic scenes, dark scenes (e.g., if image histogram mean <48), and bright scenes (e.g., if image histogram mean >193).

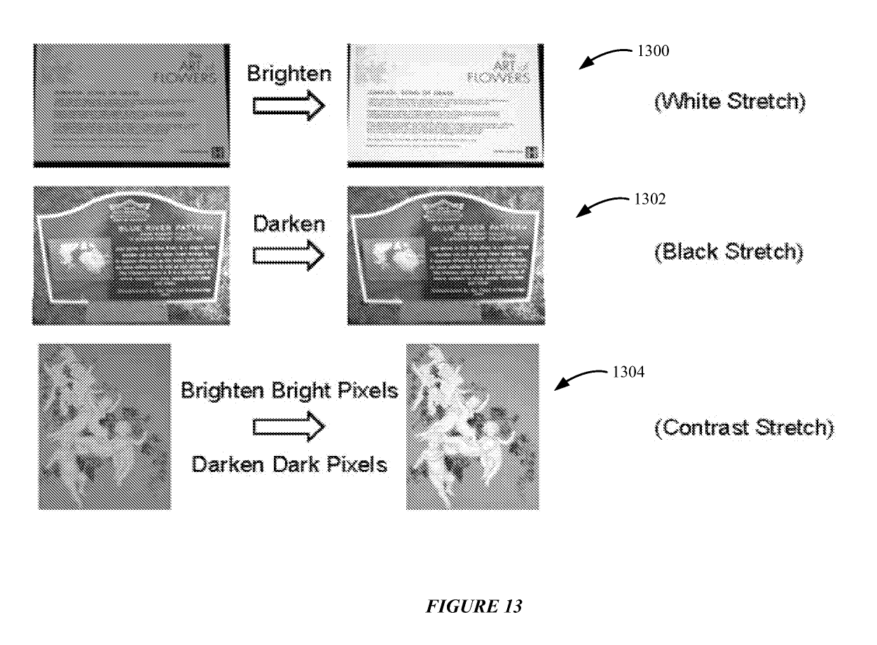

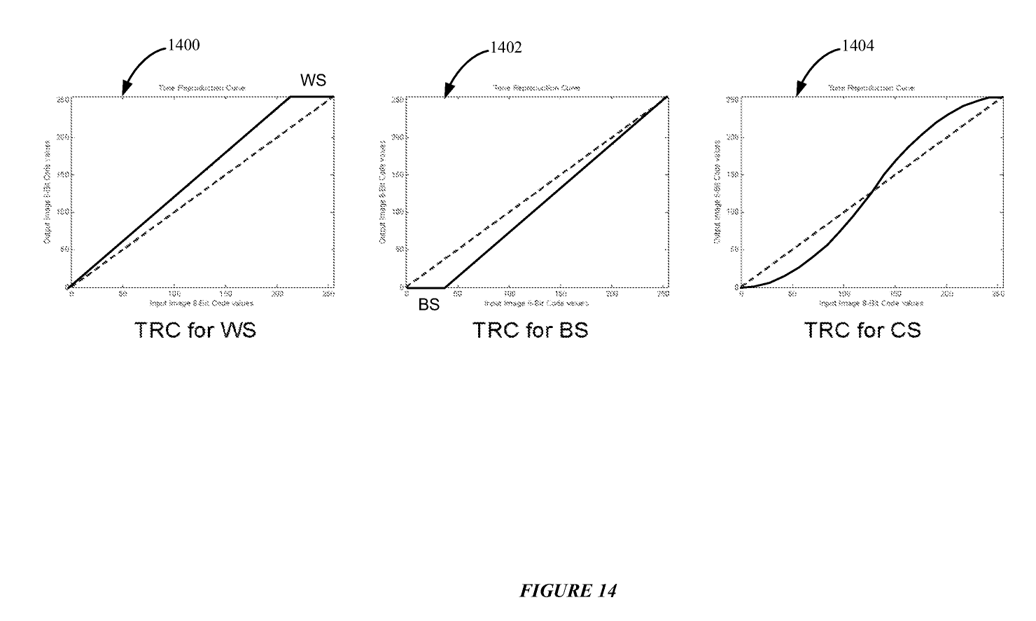

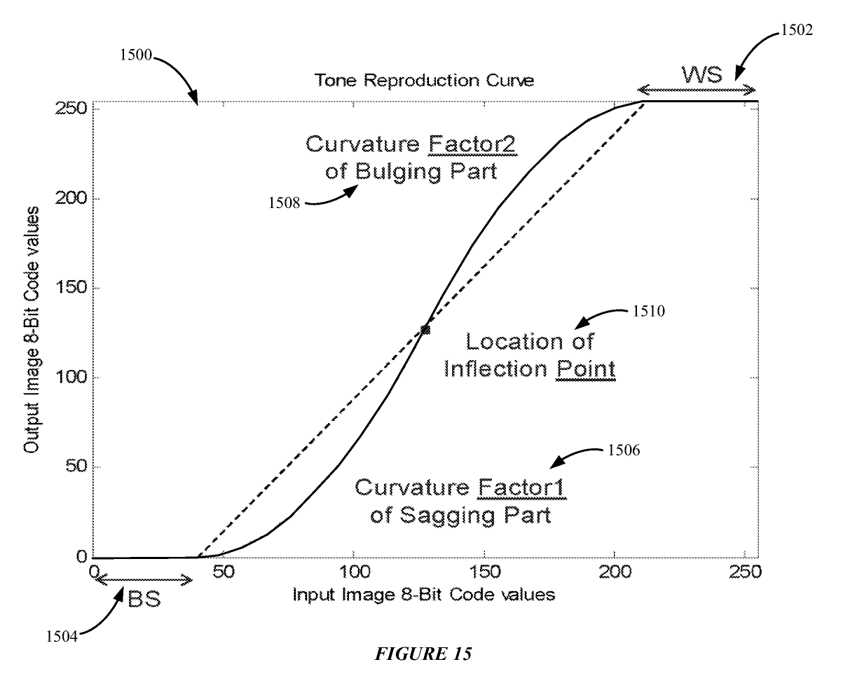

As will be understood by those skilled in the art, the subject application adopts a textbook definition of the contrast measurement as the variance of the standard deviation from the brightness average of the input image. Image contrast enhancement, according to one embodiment of the subject application, is achieved by global brightness enhancement (White Stretch 1300), global darkness enhancement (Black Stretch 1302) and contrast enhancement (Contrast Stretch with S-Curve 1304) as illustrated in FIG. 13. FIG. 14 shows the tone reproduction curve's (TRC) for White Stretch (WS) 1400, Black Stretch (BS) 1402, and Contrast Stretch with S-Curve (CS) 1404. The dashed lines in each chart show a normal tone reproduction where the output image code value equals the input image code value. FIG. 15 depicts the tone reproduction curve 1500 combining the TRCs 1400-1404 with five parameters, the amount of WS 1502, the amount of BS 1504, and three parameters for the S-Curve for CS: Curvature Factor1 1506 of the sagging part, Curvature Factor2 1508 of the bulging part, and the Inflection Point 1510 of the S-Curve. Thus, as will be appreciated by those skilled in the art, given an input image, the subject application automatically determines these five parameters, WS 1502, BS 1504, Curvature Factor1 1506, Curvature Factor2 1508, and Inflection Point 1510.

According to one example embodiment of the subject application, the amount of White Stretch (WS) is determined by the length of the long tail of the image histogram, and the amount of Black Stretch (BS) is determined by the length of the long ramp of the image histogram. After BS and WS are determined, black stretch with BS amount plus white stretch with WS amount (BS+WS) is applied to the input image M to obtain the resulting image M′. If M′ is not a low contrast image, e.g., the contrast measurement of the image M′>Upper Bound (0.06), then the input M′ is output and operations cease. Otherwise, Contrast Stretch (CS) with S-Curve is applied to the image M′. Preferably, the Curvature Factor F is calculated based on the contrast measurement of the image M′.

FIG. 16 shows the quadratic interpolation for calculating Curvature Factor 1600: a) all M′ images having (Contrast Measurement)>Upper Bound (0.06) will be left alone, i.e., with minimum Curvature Factor (0.365) which is close to identity mapping; b) all M′ images having (Contrast Measurement)<Lower Bound (0.01) will be assigned maximum Curvature Factor (0.47); and c) all M′ images that have a contrast measurement in between will be assigned Curvature Factor as a quadratic interpolation of minimum and maximum Curvature Factor between Lower Bound and Upper Bound (y=42*x2−4.9*x+0.51). The Upper Bound, Lower Bound, maximum Curvature Factor, and minimum Curvature Factor are all empirically derived from a ground truth established over suitably constructed image databases. The Curvature Factor1 for the bulging part of the S-Curve equals to the Curvature Factor while the Curvature Factor2 for the sagging part of the S-Curve is a fraction (0.5) of the Curvature Factor.

After the Curvature Factors are determined, the location of the Inflection Point is obtained by an exhaustive search. For example, a plurality of proposed inflection points, such as 10 proposed inflection points, may be defined at equal intervals spanning the intermediate image data (the data between the white stretch and black stretch regions). A tonal mapping TRC may be defined for each proposed inflection point using the previously defined Curvature Factors. Each TRC may be applied to the image and the resulting image contrast of each remapped image may be determined. The proposed inflection point that provides the highest image contrast is then selected as the Inflection Point. Other search strategies may be used to determine the Inflection Point. After the Curvature Factor1, Curvature Factor2, and the Inflection Point are determined, black stretch with BS amount plus white stretch with WS amount plus contrast stretch (CS) with Curvature Factor1, Curvature Factor2, and the Inflection Point (BS+WS+CS) is applied to the input image M to obtain the resulting image M″. Thereafter, the image M′ is output and the methodology of the preceding example embodiment terminates, as will be appreciated by those skilled in the art.

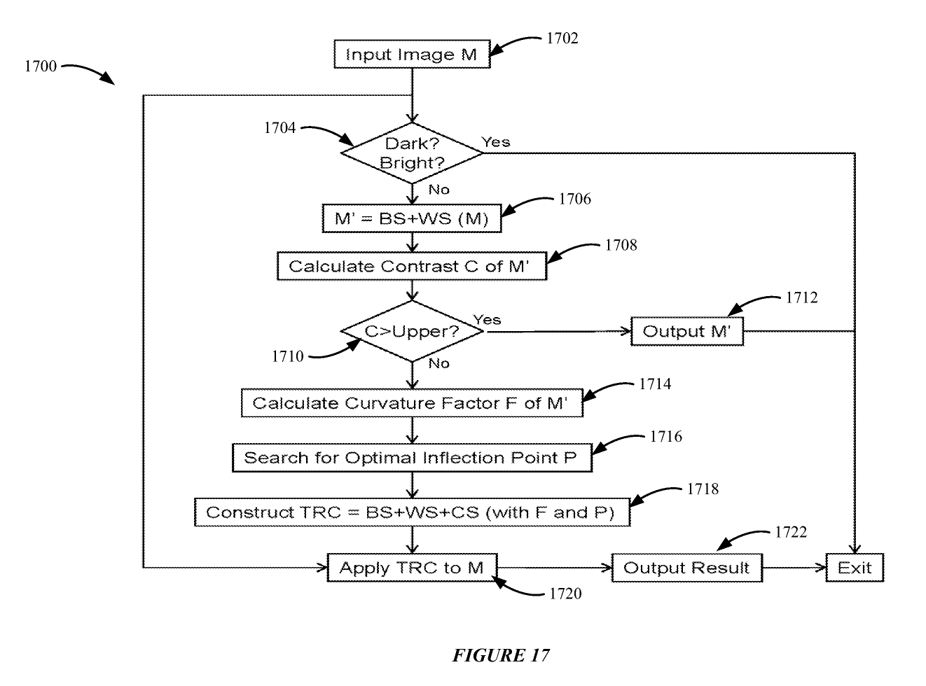

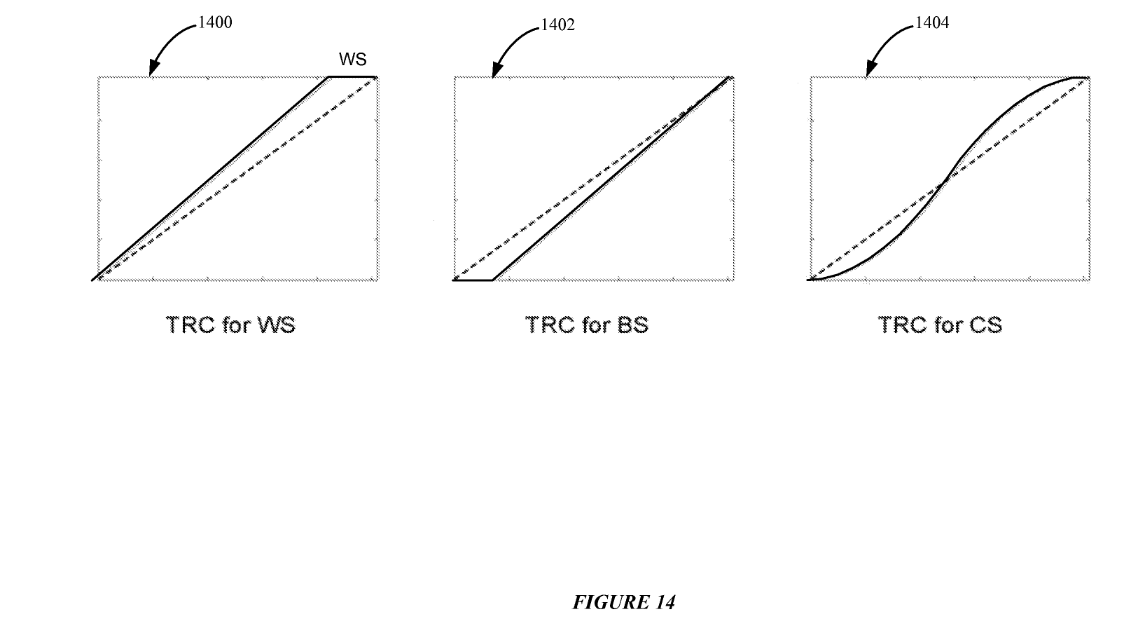

The preceding example embodiment is suitably illustrated in the flowchart 1700 of FIG. 17. Thus, upon receipt of an input image M at step 1702, flow proceeds to step 1704, whereupon a determination is made whether the input image M is a fog scene, partial fog scene, artistic scene, dark scene or bright scene. Upon a positive determination at step 1704, operations with respect to FIG. 17 terminate. When it is determined that the input image M is not a fog, partial fog, artistic, dark, or bright scene, flow proceeds to step 1706. Preferably, the long tail and long ramp associated with the input image M are detected so as to calculate the amount of black stretch (BS) and white stretch (WS). At step 1706, the BS+WS are applied to the input image M, resulting in image M′. The contrast measurement of M′ is then calculated at step 1708, and a determination is made at step 1710 whether the calculated contrast measurement of image M′ is greater than an upper bound value, e.g. Upper Bound of 0.06. If the contrast measurement does exceed the upper bound, the image M′ is output 1712 and the methodology with respect to FIG. 17 terminates. Upon a negative determination at step 1710, flow progresses to step 1714, whereupon the curvature factor F is calculated based on the contrast measurement of M′ by quadratic interpolation. At step 1716, a search is performed for the optimal location of the inflection point P. The S-Curve is then calculated with bulging curvature factor F, sagging curvature factor F/2, and the inflection point P. A tone reproduction curve (TRC) is then constructed at step 1718 using the BS+WS+CS(S-Curve). The constructed tone reproduction curve is then applied to the input image M at step 1720. The resulting image is then output at step 1722, whereafter operations with respect to FIG. 17 terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. An image contrast enhancement system comprising:
an input operable to receive an input image comprised of digitally encoded image data into a data processor including an associated data storage;
a histogram generator operable to generate histogram data corresponding to received image data;
a comparator operable to detect acceptability of received image data in accordance with a comparison of the histogram data to at least one preselected threshold value; and
a contrast adjustor selectively operable in connection with an output of the comparator, the contrast adjustor being operable to perform white stretch, black stretch, and contrast stretch on the input image in accordance with the histogram data.

2. The system of claim 1 wherein the contrast adjustor is further operable to perform the white stretch, black stretch, and contrast stretch in accordance with at least one curve property corresponding to the histogram data.

3. The system of claim 2 wherein the curve includes a tail portion and a ramp portion, and wherein the contrast adjuster is operable to complete the white stretch in accordance with a property of the tail portion and to complete the black stretch in accordance with a property of the ramp portion.

4. The system of claim 3 wherein the image adjustor further includes:
an intermediate image generator operable to generate intermediate image data in accordance with the white stretch and the black stretch;
a contrast comparator operable to compare the intermediate image data to a contrast threshold; and
a contrast corrector operable to selectively complete the contrast stretch on the intermediate image data in accordance with an output of the contrast comparator.

5. The system of claim 4 further comprising a curvature factor calculator operable to calculate a curvature factor in accordance with a contrast property of the intermediate image data, and wherein the contrast corrector is operable to perform the contrast stretch in accordance with the calculated curvature factor.

6. The system of claim 5 wherein the contrast corrector is further operable in accordance with at least one preselected boundary value.

7. The system of claim 6 wherein the contrast corrector is further operable relative to first and second boundary values in accordance with a quadratic interpolation between a minimum curvature factor and a maximum curvature factor.

8. An image contrast enhancement method comprising:
receiving input image comprised of digitally encoded image data into a data processor including an associated data storage;
generating, via the processor, histogram data corresponding to received image data;
determining acceptability of received image data in accordance with a comparison of the histogram data to at least one preselected threshold value; and
performing a contrast adjustment including a white stretch, a black stretch, and a contrast stretch on the input image in accordance with the histogram data.

9. The method of claim 8 further comprising performing the white stretch, black stretch, and contrast stretch in accordance with at least one curve property corresponding to the histogram data.

10. The method of claim 9 wherein the curve includes a tail portion and a ramp portion, and wherein the step of performing a contrast adjustment further comprises completing the white stretch in accordance with a property of the tail portion and completing the black stretch in accordance with a property of the ramp portion.

11. The method of claim 10 further comprising:
generating intermediate image data in accordance with the white stretch and the black stretch;
comparing the intermediate image data to a contrast threshold; and
selectively completing the contrast stretch on the intermediate image data in accordance with the step of comparing.

12. The method of claim 11 further comprising:
calculating a curvature factor in accordance with a contrast property of the intermediate image data; and
performing the contrast stretch in accordance with the calculated curvature factor.

13. The method of claim 12 wherein performing the contrast stretch includes performing the contrast stretch accordance with at least one preselected boundary value.

14. The method of claim 13 wherein performing the contrast stretch includes performing the contrast stretch in accordance with first and second boundary values and a quadratic interpolation between a minimum curvature factor and a maximum curvature factor.

15. An image contrast enhancement system comprising:
means for receiving input image comprised of digitally encoded image data into a data processor including an associated data storage;
means for generating, via the processor, histogram data corresponding to received image data;
means for determining acceptability of received image data in accordance with a comparison of the histogram data to at least one preselected threshold value; and
means for performing a contrast adjustment including a white stretch, a black stretch, and a contrast stretch on the input image in accordance with the histogram data.

16. The system of claim 15 further comprising means for performing the white stretch, black stretch, and contrast stretch in accordance with at least one curve property corresponding to the histogram data.

17. The system of claim 15 wherein the curve includes a tail portion and a ramp portion, and wherein the means for performing a contrast adjustment is adapted for completing the white stretch in accordance with a property of the tail portion and for completing the black stretch in accordance with a property of the ramp portion.

18. The system of claim 17 further comprising:
means for generating intermediate image data in accordance with the white stretch and the black stretch;
means for comparing the intermediate image data to a contrast threshold; and
means for selectively completing the contrast stretch on the intermediate image data in accordance with the step of comparing.

19. The system of claim 18 further comprising:
means for calculating a curvature factor in accordance with a contrast property of the intermediate image data; and
means for performing the contrast stretch in accordance with the calculated curvature factor.

20. The system of claim 19 wherein the means for performing the contrast stretch includes means for performing the contrast stretch in accordance with first and second boundary values and a quadratic interpolation between a minimum curvature factor and a maximum curvature factor.
